(19) United States
(12) Patent Application Publication
(10) Pub. No.: US 2014/0230012 A1
(43) Pub. Date: Aug. 14, 2014

(54) SYSTEMS, METHODS, AND MEDIA FOR POLICY-BASED MONITORING AND CONTROLLING OF APPLICATIONS

(71) Applicant: ARIZONA BOARD OF REGENTS for and behalf of ARIZONA STATE UNIVERSITY, Scottsdale, AZ (US)

(72) Inventor: Gail-Joon Ahn, Phoenix, AZ (US)

(21) Appl. No.: 14/239,064

(22) PCT Filed: Aug. 15, 2012
(86) PCT No.: PCT/US12/50913

§ 371 Date: Feb. 14, 2014

Related U.S. Application Data
(60) Provisional application No. 61/523,525, filed on Aug. 15, 2011.

(51) Int. Cl. G06F 21/62

(52) U.S. Cl. CPC G06F 21/629; G06F 2221/2139
USPC 726/1

(57) ABSTRACT

Systems, methods, and media for policy-based monitoring and controlling of applications are provided. Methods for policy-based monitoring and controlling of applications are provided, the methods comprising: providing a policy engine that: receives system policies and user policies; determines whether any violations and/or conflicts exist between the system policies and the user policies; and determines whether the system policies and/or user policies are violated during an installation, launch, and/or execution of an application; and providing a user interface to alert a user of violations during the installation, launch, and/or execution of the application.

### CROSS REFERENCE TO RELATED APPLICATION

This application claims the benefit of U.S. Provisional Patent Application No. 61/523,525, filed Aug. 15, 2011, which is hereby incorporated, by reference herein in its entirety,

### TECHNICAL FIELD

Systems, methods, and media for policy-based monitoring and controlling of applications are provided.

### BACKGROUND

Consumer computing and communication platforms, such as mobile devices, are ubiquitous and promise enormous productivity. However, in many instances, such platforms lack any mechanism for enterprise-class security.

On such platforms, and due to various malicious applications, system-level resources can be inappropriately accessed, which can cause severe problems such as system failure, identity theft, and policy violation.

In order to address such security issues, in some cases, applications have specific system behaviors that are normally represented in a policy and configuration file. However, in many cases, because each different application can have its own policy and configuration file, and each such file can be in a different format, security problems and configuration errors can occur because users simply accept the policies embedded in the application and those policies can conflict.

### SUMMARY

Systems, methods, and media for policy-based monitoring and controlling of applications are provided. In some embodiments, systems for policy-based monitoring and controlling of applications are provided, the systems comprising: at least one hardware processor that: provides a policy engine that: receives system policies and user policies:, determines whether any violations and/or conflicts exist between the system policies and the user policies; and determines whether the system policies and/or user policies are violated during an installation, launch, and/or execution of an application; and provides a user interface to alert a user of violations during, the installation, launch, and/or execution of the application.

In some embodiments, methods for policy-based monitoring and controlling of applications are provided, the methods comprising: providing, a policy engine that executes in at least one hardware processor that: receives system policies and user policies: determines whether any violations and/or conflicts exist between the system policies and the user policies; and determines whether the system policies and/or user policies are violated during an installation, launch, and/or execution of an application; and providing a user interface using the at least one hardware processor to alert a user of violations during' the installation, launch, and/or execution of the application.

In some embodiments, non-transitory computer-readable medium containing computer-executable instructions that, when executed by a processor, cause the processor to perform a method for policy-based monitoring and controlling of applications are provided, the method comprising: providing a policy engine that receives system policies and user policies; determines whether any violations and/or conflicts exist between the system policies and the user policies; and determines whether the system policies and/or user policies are violated during an installation, launch, and/or execution of an application; and providing a user interface to alert a user of violations during the installation, launch, and/or execution of the application.

### BRIEF DESCRIPTION OF THE DRAWINGS

FIG. 1 is a block diagram of an architecture for monitoring and controlling applications in accordance with some embodiments.

FIG. 2 is a flow diagram of a process for monitoring and controlling applications in accordance with some embodiments.

FIG. 3 is a flow diagram of a process for monitoring and controlling the installation of applications in accordance with some embodiments.

FIG. 4 is a flow diagram of a processor for monitoring and controlling the launch and execution of applications and system integrity in accordance with same embodiments.

### DETAILED DESCRIPTION

Systems, methods, and media for policy-based monitoring and controlling of applications are provided.

In order to protect against security issues, it can be desirable to maintain separate user and system spaces for respective users and provide mechanisms for monitoring and controlling applications in those spaces. For example, in some embodiments, using such a user space and mechanism, an end user can maintain and enforce their security requirements and preferences. As another example, in some embodiments, using such a system space and mechanism, a developer and an enterprise can enforce enterprise-level and application-specific, security policies.

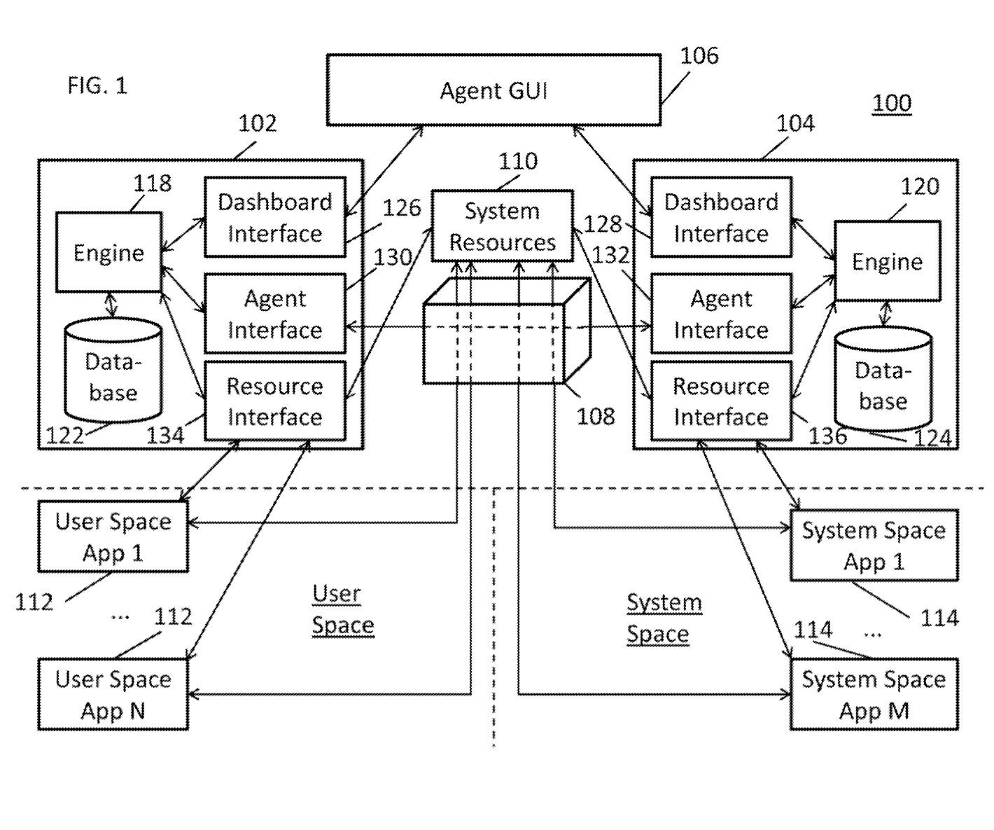

Turning to FIG. 1, a block diagram of an architecture for monitoring and controlling applications in accordance with some embodiments is illustrated. As shown, architecture 100 includes a user space agent 102, a system space agent 104, an agent graphical user interface (GUI) 106, a monitor 108, system resources 110, user space applications 112, and system space applications 114.

User space agent 102 and system space agent 104 can be used to observe and control all activities of, and access to system resources 110 by, user space applications 112 and system space applications 114 in a user space and a system space, respectively, of a device. This monitoring and control can be achieved using monitor 108, resource interface 134, and o resource interface 136. These agents can be securely and/or cryptographically designed and protected. These agents can communicate with each other to coordinate access to the system resources, via monitor 108.

These agents can control activities of applications and access to system resources based on one or more policies. These policies can include user-space policies and system-space policies. Any of these policies can be based on any suitable combination of rules, preferences, other suitable configuration information, and/or any other suitable control settings.

In accordance with some embodiments, policies can be constructed in any suitable manner. For example, in some embodiments, a policy can be defined as a 3-tuple P={Target, Condition, Effect}, where:
“Target” specifies a 3-tuple {Subject, Resource, Action} to which the policy is applicable, where:
   “Subject” is a set of entities to which authorization may be granted;
   “Resource” is a set of entities to which access is to be mediated: and
   “Action” is a set of actions to be authorized or forbidden;
“Condition” specifies restrictions on the attributes in the target and refines the applicability of the policy; and
“Effect” indicates whether the policy authorizes or denies the Action in the Target.

In some embodiments, to evaluate a request, such it policy can be reviewed to determine if the request satisfies both the target and condition of the policy, and, if so, a response can be sent with the decision specified by the effect element in the policy. Otherwise, the response can be sent with a “deny.”

In accordance with some embodiments, policies can be for any suitable type of activity. For example, in some embodiments, policies can be used to regulate communications between application components. More particularly, for example, in some embodiments, such policies can be used to regulate Inter-Component Communications (ICC) between application components in an ANDROID operating system. In such a policy: the Target of the policy can specify a Subject corresponding to an application group and application, can specify a Resource corresponding to a component, and can specify an Action corresponding to APIs that initiate ICC to four types of components including startActivity, bindService, sendBroadcast and accessContentProvider, the Condition of the policy can be defined by attributes derived from the ICC intent, indicating the constraints on action, category and data; and the Effect of the policy can be defined as “deny.” Still mare particularly, for example, in some embodiments, such a policy can be constructed as follows to prevent an application “Gallery” from using a camera via ICC:

```
“ICCPolicy_PermissionReDelegation”: {
      “target”: {
            “subject”: [10026],
            “resource”: [10016],
            “action”: [“Activity”]
      },
      “condition”: [“*”],
      “effect”: “deny”
}
```

As another example, in some embodiments, policies can be used to regulate communications between applications and system processes. More particularly, for example, in some embodiments, such policies can be used to regulate Binder Inter-Process Communications (IPC) between application processes and system processes in an ANDROID operating system. In such a policy: the Target of the policy can specify a Subject corresponding to a group and application and a Resource corresponding to a service, and can specify an Action corresponding to a call; the Condition of the policy can specify a command code of a command to be executed by a remote service and the Effect of the policy can be defined as “deny.” Still more particularly, for example, in some embodiments, such a policy can be constructed as follows to prevent accessing of a phone's device ID while allowing accessing, of the phone's state:

```
“BinderPolicy_CapabilityRevoking”: {
      “target”: {
            “subject”: [10057],
            “resource”:
                  [“com.android.internal.telephony.IPhoneSubInfo”],
            “action”: [“Call”]
      },
      “condition”: [“cmd=1”],
      “effect”: “deny”
}
```

As another more particular example of a policies being used to regulate communications between applications and system processes, in sonic embodiments, such policies can be used to regulate Unix-type IPC communications between application processes and system processes in an ANDROID operating system. In such a policy: the Target of the policy can specify a Subject corresponding to an application group, application, system, and file and a Resource corresponding to a file, file system, process, and Linux IPC channel, and can specify an Action corresponding to the following categories of Linux system calls: mode, filesystem, task, and Linux IPC: the Condition of the policy can specify the name of the actual system call to be triggered and its parameters; and the Effect of the policy can be defined as “deny,” Still more particularly, for example, in some embodiments, such policies can be constructed as follows to prevent an application from accessing Vold via a Unix-type IPC:

```
“OSPolicy_Gingerbreak”: {
      “target”: {
            “subject”: [2000],
            “resource”: [“vold”],
            “action”: [“netlink”]
      },
      “condition”: [“cmd=netlink_send”],
      “effect”: “deny”
}
“OSPolicy_ZergRush”: {
      “target”: {
            “subject”: [2000],
            “resource”: [“vold”],
            “action”: [“local_socket”]
      },
      “condition”: [“cmd=socket_connect”],
      “effect”: “deny”
}
```

Monitor 108 can be a reference monitor or hardware-assisted monitor (e.g., Trusted Platform Module based monitor) in some embodiments. As stated above, and as shown in FIG. 1, monitor 108 can be used to observe and control all activities of, and access to system resources 110 by, user space applications 112 and system space applications 114.

Any suitable one or more monitor functions can be used to implement monitor 108 and those monitors can monitor any suitable activities. For example, in some embodiments an ICC monitor function can be used to intercept an ICC call before the message is delivered to the recipient component. After that, the ICC monitor function can send a request to a user agent asking whether the call should be allowed to pass or be denied. The request can include the original message, a list of recipient components, and the caller application's UID. Next, the user agent can make a decision based on ICC policies (e.g., as described above). If the request matches a policy, the user agent can issue the effect as indicated in the policy. Otherwise, the default effect (“deny”) can be issued. After that, the user agent can send the issued decision back to the monitor. If the request is allowed, the monitor can deliver the message. Otherwise, the monitor can shut down the ICC channel.

As another example, in some embodiments, a Binder IPC monitor function can be used to intercept Binder ICP calls to mitigate attacks that bypass the permission system to access system services in ANDROID operating systems. Because the Binder IPC monitor function can mediate Binder IPC calls before the permission framework is consulted, the Binder IPC monitor function can enable the dynamic revocation of granted capabilities. Furthermore, the Binder IPC monitor function can offer granularity at service command level, whereas the granularity of ANDROID permission framework is based on individual permission that usually corresponds to multiple commands and may be too coarse for many tasks.

In some embodiments, the Binder IPC monitor function can be used to intercept all Binder IPC calls before Binder triggers remote services. Then, the Binder IPC monitor function can query a user agent with the caller's UID, the service's unique name, and the command and code. The user agent can then issue a decision of whether to allow the call based on Binder policies. If the request is perm permitted, the Binder IPC monitor function can deliver the command code and the data to the service. Next, the service can process the data as instructed by the command code, for example, accessing die resources of the service. Otherwise, if the request is disallowed, the Binder IPC monitor function can shut down the Binder IPC channel.

As still another example, in some embodiments, a Unix-type IPC monitor function can be provided. This monitor function can intercept Unix-type IPC calls and then query a user agent's policy engine. In some embodiments, the Unix-type IPC monitor function can be isolated from other monitor functions to prevent potential attacks on the Unix-type IPC monitor function.

In some embodiments, rather than denying a call, a monitor function can instead return anonymized privacy data or bogus values.

As shown in FIG. 1, each of agents 102 and 104 can include an engine 118 or 120, a database 122 or 124, a dashboard interface 126 or 128, an agent interlace 130 or 132, and a resource interface 134 or 136.

In accordance with sonic embodiments, engines 118 and 120 can be used to enforce policies on applications 112 and 114 in the user space and the system space, respectively. Engines 118 and 120 can access such policies from their storage location(s) in databases 122 and 124, respectively.

In sonic embodiments, in doing so, engines 118 and 120 can perform policy management functions. These policy management functions can analyze policies and check the conformance between system configuration and users/developers' policies based on system resources. The policy management functions can check whether any conflicts and violations among policies exist, and can verify conformance between actual system status and policies provided by users/developers/enterprises.

Engines 118 and 120 can contain a policy engine that parses the policies and issues decisions for incoming requests.

Policy files can be stored in an internal read-only file system. In addition, access to policies can be restricted to the user agents to prevent tampering or disabling of the monitors' functions.

In some embodiments, engines 118 and 120 can provide information on policies to a user. For example, a user can run a query on active policies via the engines, and the results of that query can be provided to the user via dashboard interface 126 or 128 and agent GUI 106.

In some embodiments, engines 118 and 120 can validate the integrity of a device by performing, for example, e, one or more malware scans (e.g., as signature based scan), verifying checksums using a Hash function, detecting anomalous system behavior, etc.

In some embodiments, an integrity subsystem can be provided that measures and verifies critical system components at runtime. In some embodiments, the integrity subsystem can detect tampered files and shut components, applications, etc. down to prevent further damage caused by attacks.

Any suitable mechanisms can be used to implement the integrity subsystem in some embodiments. For example, the integrity subsystem can include Trusted Platform Module (TPM) hardware, an integrity Measurement Architecture (IMA) kernel module, and a Trusted Computing Group (TCG) Software Stack (TSS) in some embodiments. In some of these embodiments, before the integrity subsystem is activated, a user can initiate the IMA kernel module to generate hashes of trusted components and store the hashes in the TPM hardware. Then, the IMA kernel module can form new hashes of executable contents when they are loaded into memory, and then verify the new hashes against those trusted hashes in TPM hardware. In this way, inconsistency can be detected when the tampered code is loaded.

The IMA kernel module can be implemented in any suitable manner. For example, in some embodiments, the IMA kernel module can be implemented as a Linux Security Module (LSM) implementation that uses a file_mmap hook to intercept loading executable code.

In addition to measuring application package files and ANDROID system files, the integrity subsystem can also measure and verify components of system 100.

To alert a user about potential threats, the IMA kernel module can write a log file (e.g., on an SD card) and halt components, applications, etc. to prevent further damage.

Databases 122 and 124 can be used to store policies (e.g., such as ICC policies, Binder IPC policies, Unix-type IPC policies, etc.) in accordance with some embodiments. Any suitable database or storage mechanism can be used to provide databases 122 and 124. In some embodiments, databases 122 and 124 can each include: (1) a taxonomy of system resources that can be referred to when policies are constructed; and (2) an ontology of policy elements that can be used for policy specification and representation in as semantically generic manner, and that can be used to store policies.

Databases 122 and 124 can also be used to store any other suitable data, such as malware signatures, etc.

As described above, dashboard interfaces 126 and 128 along with agent GUI 106 can be used to view results of a query on active policies. In some embodiments, dashboard interfaces 126 and 128 and agent GUI 106 can additionally or alternatively be used to specify and store new policies, and update and store existing policies. In some embodiments, agent GUI 106 can provide prototype policies upon which other policies can be based, as well as provide management tools for managing policies.

Agent GUI 106 can be any suitable graphical user interface, such as a Web browser, in some embodiments. Dashboard interfaces 126 and 128 can be any suitable functions for providing and/or interacting with agent GUI 106, such as a Web server's capability for providing an agent GUI Web page. Together, agent GUI 106 and dashboard interfaces 126 and 128 can provide queries and store instructions to engines 118 and 120, and receive results from engines 118 and 120, in some embodiments.

Agent interfaces 130 and 132 can be used by agents 102 and 104 to communicate with each other. These agent interfaces can be any suitable interfaces and can communicate in any suitable manner for an suitable purpose m some embodiments.

Resource interfaces 134 and 136 can be interfaces that provide access to system resources 110. Resource interfaces 134 and 136 can be customized to the system resources available on a device. For example, interfaces 134 and 136 can provide a proxy for each register, memory location, service, system libraries, system functions, etc. that is provided on a device in some embodiments. Under the control of engines 118 and 120 based on policies, resource interface can control when why, how by whom, and which system resources can be accessed in some embodiments.

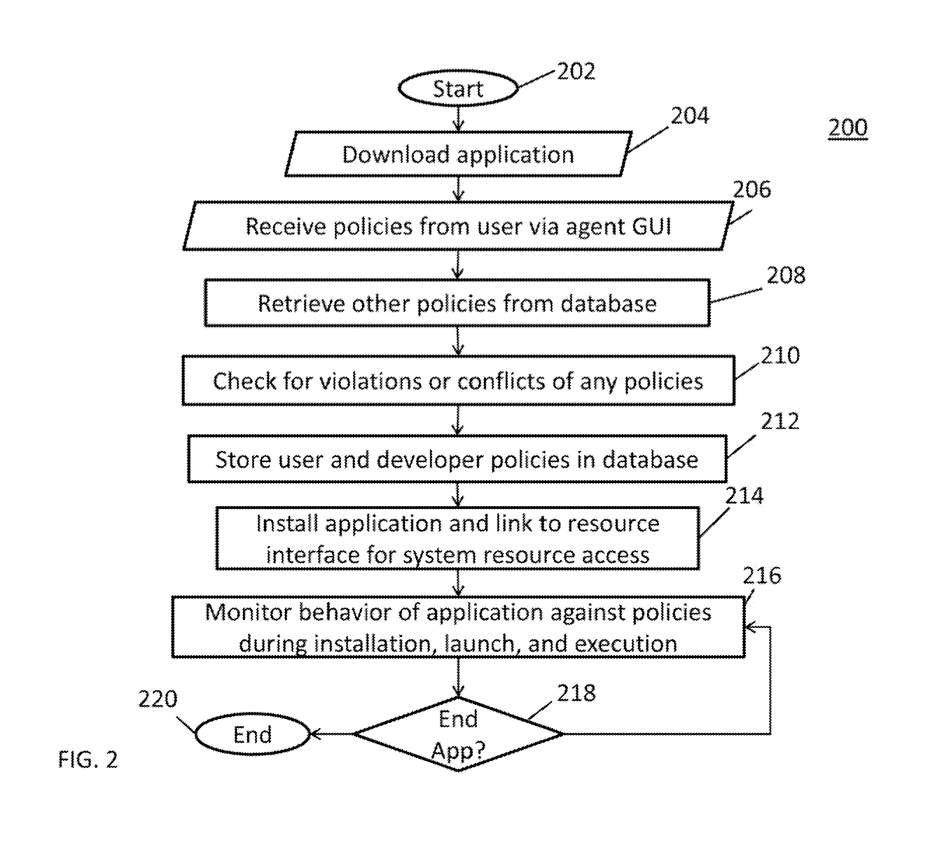

Turning to FIG. 2, a process 200 for installing and monitoring the behavior of an application in accordance with some embodiments is shown. As illustrated, after process 200 begins at 202, the process can allow an application to be downloaded onto a device at 204. Any suitable technique for downloading and storing the application can be used in some embodiments. Next, at 206, policies can be received from a user via an agent GUI. Any suitable GUI can be used in some embodiments. Other policies can then be retrieved from one or more databases at 208. Such other policies can be user-entered policies, developer entered policies, and/or system policies in some embodiments. Then, at 210, process 200 can check for violations and/or conflicts of any policies. Any suitable technique for checking for violations and/or conflicts of the policies can be used in some embodiments. User and developer policies can then be stored in a database at 212. Any suitable database can be used in some embodiments. At 214, the application can next be installed and linked to a resource interface for systems resource access. This linking can be via a monitor, such as monitor 108, and/or resource interface, such as resource interface 134 and/or resource interface 136, in some embodiments. During installation, launch, and execution, process 200 can then monitor the behavior of the application against any suitable policies at 216. Next, at 218, process 200 can determine if the application has ended, and, if so, the process can end at 220. Otherwise, process 200 can loop back to 216.

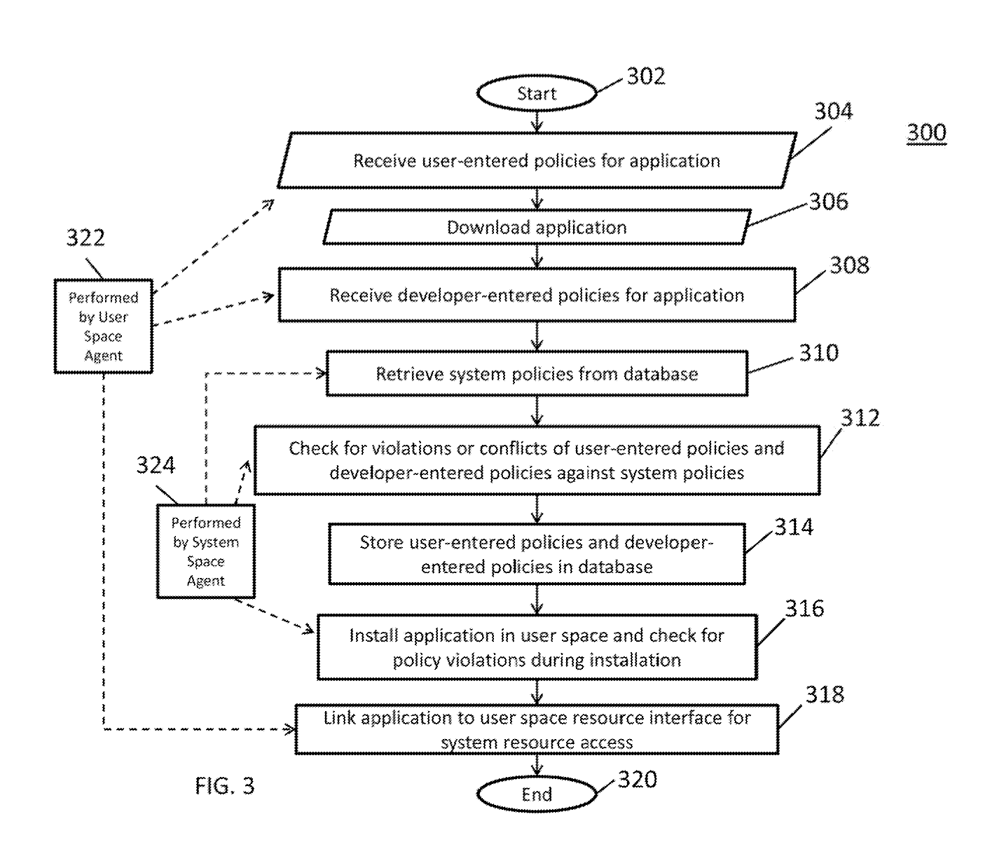

Turning to FIG. 3, another process 300 for installing, and monitoring the installation of an application in accordance with some embodiments is shown. As illustrated, after process 300 begins at 302, the process can receive user-entered policies for an application 304. These can be received in any suitable way, such as from a GUI, from a configuration file, from user settings, etc. Next, at 306, process 300 can allow the application to be downloaded. The application can be downloaded using any suitable technique and can be stored in any suitable area in accordance with some embodiments. Developer-entered policies for the application can next be received at 308. These policies can be received from any suitable source, such as the application's installation files. Next, at 310, process 300 can check for violations or conflicts of user-entered policies crud developer-entered policies against system policies. Any suitable technique for checking for violations and/or conflicts of the policies can be used in some embodiments. User and developer policies can then be stored in a database at 314. Any suitable database can be used in some embodiments. Next, at 316, the application can be installed in user space and the installation monitored for any policy violations. Finally, the application can be linked to system resources via a monitor, such as monitor 108, and/or a user-space resource interface, such as resource interface 134, at 318 and then process 300 can end at 320.

As shown by 322, steps 304, 108, and 118 can be performed by a user space agent in accordance with some embodiments. As shown by 324, steps 310, 312, and 316 can be performed by a system space agent in accordance with some embodiments.

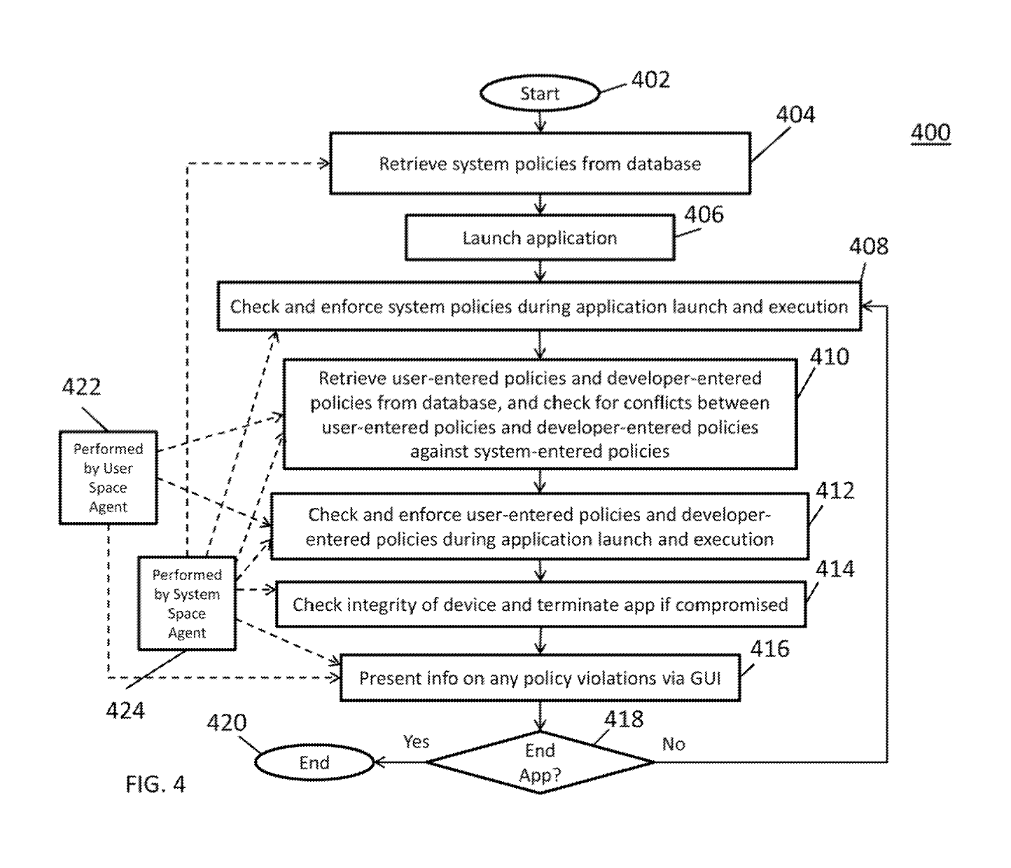

Turning to FIG. 4, another process 400 for monitoring the launch and execution of an application and checking system integrity in accordance with some embodiments is shown As illustrated, after process 400 begins at 402, the process can retrieve system policies front a database 404. These policies can be retrieved from any suitable database in some embodiments. Next, at 406, the application can be launched. Any suitable technique for launching the application can be used, and the application can be launched in response to any suitable event. At 408, process 400 can check and enforce system policies during application launch and execution. Any suitable technique for checking and enforcing policies can be used. Then, at 410, process 400 can retrieve user-entered policies and developer entered policies from a database, and check for conflicts between these policies and system policies. Non-conflicting policies can then be checked and enforced against the application during its launch and execution at 412. Next, at 414, process 400 can check the integrity of the device and terminate the execution of the application if the integrity is compromised. Any information on policy violations and/or integrity issues can then be detected and presented to the user via a GUI at 416.

Finally, at 418, process 400 can determine if the application has ended, and, if so, the process can end at 420. Otherwise, the process can loop back to 408.

As shown by 422, steps 410, 412, and 416 can be performed by a user space agent in accordance with some embodiments. As shown by 424, steps 404, 408, 410, 412, 414, and 416 can be performed by a system space agent in accordance with some embodiments.

In sonic embodiments, any suitable hardware an be used to provide the components and functions described above, and such hardware can be implemented in one or more general purpose devices such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc., and can be configured to operate in response to software instructions consistent with the functionality described herein.

In accordance with some embodiments, the systems, methods, and media described herein can be used for any suitable purpose. For example, in some embodiments, these mechanisms can be used to provide a firewall to protect certain components, applications, etc. As of a mobile device. Such a firewall can be implemented using policies which control what can pass between the firewalled area and non-firewalled area. As another example, in some embodiments, these mechanisms can be used to protect data, to automatically encrypt and decrypt data (e.g., in which case, a policy's Action can specify that the data is to be encrypted in a certain manner to automatically verify data (e.g., using digital signatures), etc. As still another example, in some embodiments, these mechanisms can be used to restrict access to personal data (e.g., such as name(s), address(es), phone number(s), date(s) of birth, age(s), gender(s), social security number(s), identification number(s), passport number(s), credit card number(s), bank account number(s), user identifier(s), user names(s), email address(es), password(s), etc.). As yet another example, in some embodiments, these mechanisms can be used to protect against malicious applications by preventing such applications from accessing unauthorized services, functions, applications, data, etc. As described above, the permitted activities of an application can be configured by a user during installation of the application, and all other activities can be blocked unless subsequently authorized by the user.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A system for policy-based monitoring and controlling of applications, comprising:
at least one hardware processor that:
provides a policy engine that:
receives system policies and user policies;
determines whether any violations and/or conflicts exist between the system policies and the user policies; and
determines whether the system policies arid/or user policies are violated during an installation, launch, and/or execution of an application; and
provides a user interface to alert a user of violations during the installation, launch, and/or execution of the application.

2. The system of claim 1, wherein the at least one hardware processor also stores the system policies and/or user policies in a database.

3. The system of claim 1, wherein the at least one hardware processor also monitors accesses to system resources by the application.

4. The system of claim 1, wherein the at least one hardware processor also checks system integrity of the device.

5. The system of claim 1, wherein the at east one hardware processor also provides a user agent and a system agent.

6. The system of claim 1, wherein the at least one hardware processor also receives a specification of a system policy and/or a user policy from a user.

7. A method for policy-based monitoring: and controlling of applications, comprising:
providing a policy engine that executes in at least one hardware processor that:
receives system policies and user policies;
determines whether any violations and/or conflicts exist between the system policies and the user policies; and
determines whether the system policies and/or user policies are violated during an installation, launch, and/or execution of an application; and
providing a user interface using the at least one hardware processor to alert a user of Violations during the installation, launch, and or execution of the application.

8. The method of claim 7, further comprising, storing the system policies and/or user policies in a database.

9. The method of claim 7, further comprising monitoring accesses to system resources by the application.

10. The method of claim 7, further comprising checking system integrity of the device.

11. The method of claim 7, further comprising providing a user agent and a system agent.

12. The method of claim 7, further comprising receiving a specification of a system policy and/or a user policy.

13. A non-transitory computer-readable medium containing computer-executable instructions that, when executed by a processor, cause the processor to perform a method for policy-based monitoring and controlling of applications, the method comprising:
providing a policy engine that:
receives system policies and user policies;
determines whether any violations and/or conflicts exist between the system policies and the user policies; and
determines whether the system policies and/or user policies are violated during an installation, launch, and/or execution of an application; and
providing a user interface to alert a user of violations during the installation, launch, and/or execution of the application.

14. The non-transitory computer-readable medium of claim 13, wherein the method further comprises storing the system policies and/or user policies in a database.

15. The non-transitory computer-readable medium of claim 13, wherein the method further comprises monitoring accesses to system resources by the application.

16. The non-transitory computer-readable medium of claim 13, wherein the method further comprises checking system integrity of the device.

17. The non-transitory computer-readable medium of claim 13, wherein the method further comprises providing a user agent and a system agent.

18. The non-transitory computer-readable medium of claim 13, wherein the method further comprises receiving a specification of a system policy and/or a user policy from a user.
